(19) United States
(12) Patent Application Publication
(10) Pub. No.: US 2015/0215886 A1
(43) Pub. Date: Jul. 30, 2015

(54) USER DIRECT MODE COMMUNICATION APPARATUS AND TIME SYNCHRONIZATION METHOD THEREOF

(71) Applicant: Institute For Information Industry, Taipei (TW)

(72) Inventors: Shao-Yu LIEN, Kaohsiung City (TW); Chun-Che CHIEN, Taipei City (TW)

(21) Appl. No.: 14/609,336

(22) Filed: Jan. 29, 2015

Related U.S. Application Data
(60) Provisional application No. 61/932,803, filed on Jan. 29, 2014.

(51) Int. Cl. H04W 56/00; H04W 4/00

(52) U.S. Cl. CPC H04W 56/0015; H04W 4/005

(57) ABSTRACT

A user direct mode communication apparatus and a time synchronization method thereof are provided. The user direct mode communication apparatus receives a synchronization signal from at least one network apparatus. The synchronization signal includes time information and apparatus information. The user direct mode communication apparatus determines an apparatus weight of the at least one network apparatus according to the apparatus information, and calculates a network synchronization time according to the apparatus weight and the time information.

### PRIORITY

This application claims priority to U.S. Provisional Patent Application No. 61/932,803 filed on Jan. 29, 2014, which is hereby incorporated herein by reference in its entirety.

### FIELD

The present invention relates to a user direct mode communication apparatus and a time synchronization method thereof; and more particularly, the user direct mode communication apparatus and the time synchronization method thereof according to the present invention can accomplish the time synchronization for network apparatuses of different network environments.

### BACKGROUND

In the prior art, for consistency of services used by apparatuses in a network environment, a same time basis needs to be used among the apparatuses. Correspondingly, network time synchronization has been developed. In general network time synchronization mechanisms, primarily the time of a base station is used as a basis, and a mobile apparatus receiving a synchronization signal from the base station will adjust its own time by directly taking the time of the base station as a basis.

In the direct mode communication system, when there is a base station available, the mobile apparatus still uses the synchronization signal from the base station as a basis for synchronization. However, if no base station is available, the mobile apparatus will directly take a random network synchronization signal as a basis for synchronization.

However, the network architectures of direct mode network communication systems vary greatly. Therefore, performing the time synchronization by taking only the synchronization signal of the base station as a basis or taking only a random network synchronization signal as a basis leads to a low flexibility in time synchronization processing and poor consistency in time synchronization.

As described above, the current direct mode communication network protocols are still unable to efficiently achieve more precise time synchronization for network apparatuses of different network environments. Accordingly, an urgent need exists in the art to provide a solution capable of achieving efficient and precise time synchronization for different network environments in direct mode communication network architectures to overcome the shortcomings of the prior art.

### SUMMARY

A primary objective of the present invention includes providing a time synchronization method for a user direct mode communication apparatus, which comprises: (a) enabling the user direct mode communication apparatus to receive a synchronization signal from at least one network apparatus, wherein the synchronization signal comprises time information and apparatus information; (b) enabling the user direct mode communication apparatus to determine an apparatus weight of the at least one network apparatus according to the apparatus information; and (c) enabling the first user direct mode communication apparatus to calculate a network synchronization time according to the apparatus weight and the time information.

To achieve the aforesaid objective, certain embodiments of the present invention include a user direct mode communication apparatus, which comprises a transceiver and a processor. The transceiver is configured to receive a synchronization signal from at least one network apparatus, and the synchronization signal comprises time information and apparatus information. The processor is configured to: determine an apparatus weight of the at least one network apparatus according to the apparatus information; and calculate a network synchronization time according to the apparatus weight and the time information.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a block diagram of a first user direct mode communication apparatus according to a first embodiment of the present invention;

FIG. 1B is a schematic view illustrating that the first user direct mode communication apparatus according to the first embodiment of the present invention performs time synchronization;

FIG. 2A is a block diagram of a first user direct mode communication apparatus according to a second embodiment of the present invention;

FIG. 2B is a schematic view illustrating that the first user direct mode communication apparatus according to the second embodiment of the present invention performs time synchronization;

FIG. 2C is a schematic view illustrating that the first user direct mode communication apparatus according to the second embodiment of the present invention chooses a base station before synchronization;

FIG. 2D is a schematic view illustrating that the first user direct mode communication apparatus according to the second embodiment of the present invention directly performs the synchronization with respect to different base stations;

FIG. 3A is a block diagram of a first user direct mode communication apparatus according to a third embodiment of the present invention;

FIG. 3B is a schematic view illustrating that the first user direct mode communication apparatus according to the third embodiment of the present invention performs time synchronization;

FIG. 4A is a block diagram of a first user direct mode communication apparatus according to a fourth embodiment of the present invention;

FIG. 4B is a schematic view illustrating that the first user direct mode communication apparatus according to the fourth embodiment of the present invention performs time synchronization;

FIG. 5A is a block diagram of a first user direct mode communication apparatus according to a fifth embodiment of the present invention;

FIG. 5B is a schematic view illustrating that the first user direct mode communication apparatus according to the fifth embodiment of the present invention performs time synchronization;

FIG. 6 is a flowchart diagram of a time synchronization method according to a sixth embodiment of the present invention;

FIG. 7 is a flowchart diagram of a time synchronization method according to a seventh embodiment of the present invention;

FIG. 8 is a flowchart diagram of a time synchronization method according to an eighth embodiment of the present invention;

FIG. 9 is a flowchart diagram of a time synchronization method according to a ninth embodiment of the present invention; and

FIG. 10 is a flowchart diagram of a time synchronization method according to a tenth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these embodiments. Therefore, description of these example embodiments is only for purpose of illustration rather than to limit the present invention.

In the following embodiments and the attached drawings, elements unrelated to the present invention are omitted from depiction; and dimensional relationships among individual elements in the attached drawings are illustrated only for ease of understanding, but not to limit the actual scale.

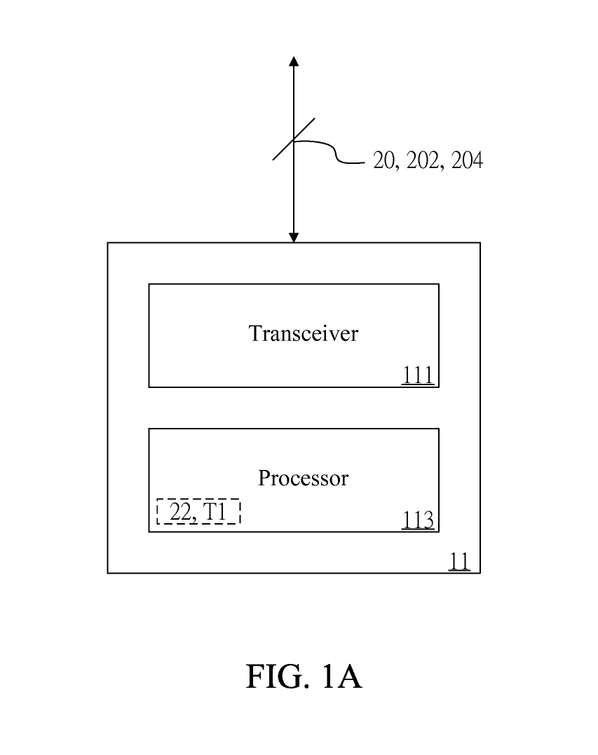

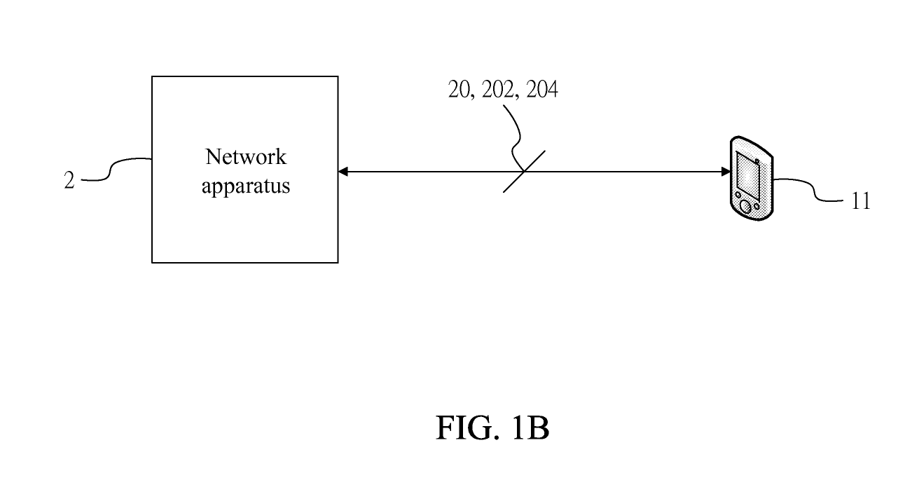

Please refer to FIGS. 1A-1B together. FIG. 1A is a block diagram of a first user direct mode communication apparatus 11 according to a first embodiment of the present invention. The first user direct mode communication apparatus 11 comprises a transceiver 111 and a processor 113. FIG. 1B is a schematic view illustrating that the first user direct mode communication apparatus 11 according to the first embodiment of the present invention performs time synchronization. The process of performing the time synchronization by the user direct mode communication apparatus of the present invention will be further described hereinafter.

Firstly, when the first user direct mode communication apparatus 11 needs to perform the time synchronization, it mainly searches for any apparatus in the network that transmits a synchronization signal. In the first embodiment, the transceiver 111 of the first user direct mode communication apparatus 11 receives a synchronization signal 20 from at least one network apparatus 2. The synchronization signal 20 comprises time information 202 and apparatus information 204.

Next, the processor 113 of the first user direct mode communication apparatus 11 may determine an apparatus weight 22 of the at least one network apparatus 2 according to the apparatus information 204. Finally, the processor 113 of the first user direct mode communication apparatus 11 calculates a network synchronization time T1 according to the apparatus weight 22 and the time information 202 to complete the time synchronization of the first user direct mode communication apparatus 11.

It shall be particularly appreciated that, besides receiving the synchronization signal to calculate the synchronization time, the first user direct mode communication apparatus 11 may further transmit the synchronization signal to other user direct mode communication apparatuses so that the other user direct mode communication apparatuses calculate their synchronization times accordingly. In detail, when the first user direct mode communication apparatus 11 enters a synchronization period, the processor 113 may determine whether to calculate the synchronization time or to transmit the synchronization signal according to a synchronization probability value (not depicted).

Further speaking, the synchronization probability value may be a value decided by the user depending on the network environment, and ranges between 0 and 1. Accordingly, the processor 113 of the first user direct mode communication apparatus 11 may, according to the synchronization probability value, determine to: (1) calculate the network synchronization time T1 according to the received synchronization signal; or (2) transmit a first user synchronization signal (not depicted) to other user direct mode communication apparatuses directly via the transceiver 111 so that the other user direct mode communication apparatuses calculate their own synchronization times.

In this way, the speed and accuracy of calculating the synchronization times in the network environment can be controlled through adjusting the magnitude of the synchronization probability value. In other words, if the synchronization probability value indicates a higher probability of calculating the synchronization time, then the accuracy of calculating the synchronization time by the apparatus may be increased; and otherwise, if the synchronization probability value indicates a higher probability of transmitting the synchronization signal, then the time synchronization speed of the apparatuses in the network may be increased.

Additionally, in other more detailed implementations, the apparatus information 204 may further comprise an apparatus signal strength (not depicted) or a synchronization message hopping number of times (not depicted). Thus, because the apparatus signal strength represents reliability of an apparatus and the synchronization message hopping number of times represents accuracy of the content of the synchronization message, the processor 113 can determine importance of the at least one network apparatus 2 according to the apparatus signal strength or the synchronization message hopping number of times, that is, to determine the apparatus weight 22 of the at least one network apparatus 2.

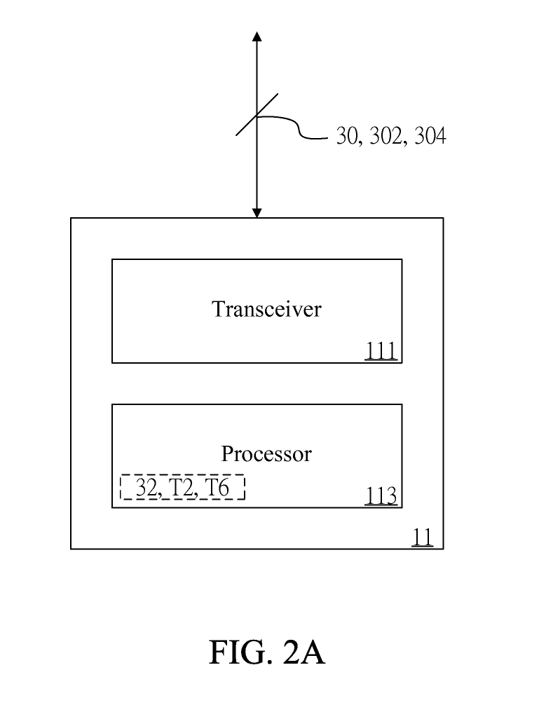

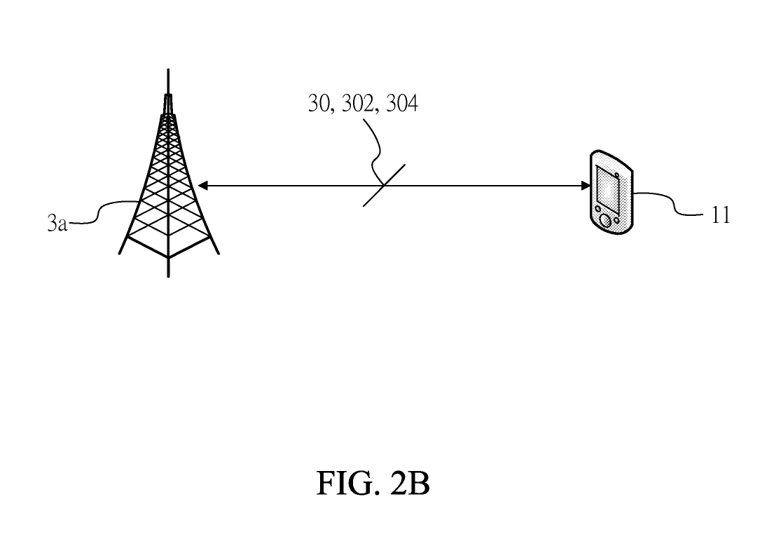

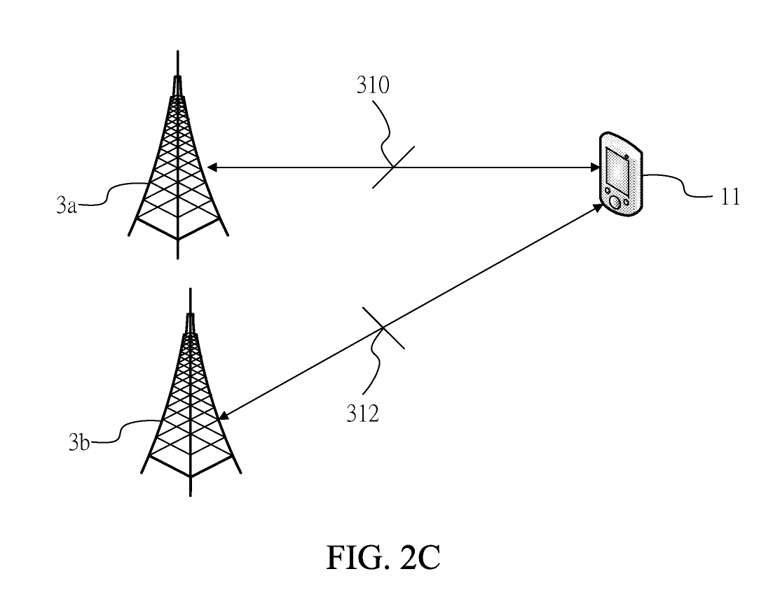

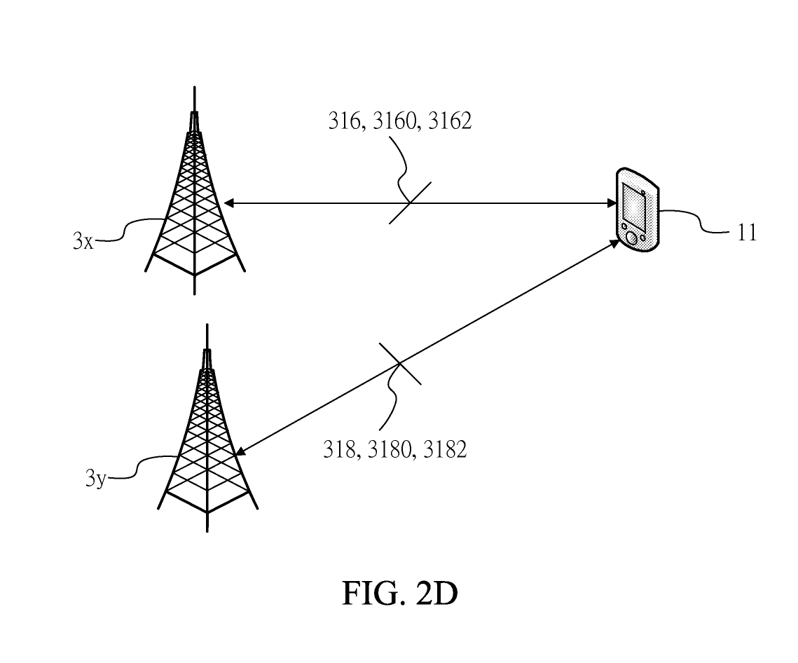

Please refer to FIGS. 2A-2B together. FIG. 2A is a block diagram of a first user direct mode communication apparatus 11 according to a second embodiment of the present invention. FIG. 2B is a schematic view illustrating that the first user direct mode communication apparatus 11 according to the second embodiment of the present invention performs time synchronization. It shall be particularly appreciated that, the architecture of the second embodiment is the same as that of the previous embodiment, so components bearing the same reference numerals also have the same functions and, thus, will not be further described herein. However, the second embodiment mainly describes a case where the network apparatus is a base station.

Firstly, when the first user direct mode communication apparatus 11 needs to perform the time synchronization, it mainly searches for any apparatus in the network that transmits a synchronization signal. In the second embodiment, the transceiver 111 of the first user direct mode communication apparatus 11 receives a synchronization signal 30 from a first base station 3a. The synchronization signal 30 comprises time information 302 and apparatus information 304. Then, the processor 113 of the first user direct mode communication apparatus 11 may determine that the apparatus weight of the first base station 3a is a base station weight 32 according to the apparatus information 304. The base station weight 32 is used for the first user direct mode communication apparatus 11 to determine that the network apparatus is the base station.

Finally, the processor 113 of the first user direct mode communication apparatus 11 calculates a network synchronization time T2 according to the base station weight 32 and the time information 302 to complete the time synchronization of the first user direct mode communication apparatus 11. It shall be particularly appreciated that, because the synchronization object is the first base station 3a, the first user direct mode communication apparatus 11 may directly set the synchronization time T2 to be a base station time (not depicted) of the first base station 3a when calculating the network synchronization time T2.

Additionally, when there is a plurality of base stations in the network in other implementations, the first user direct mode communication apparatus 11 may firstly choose a synchronization target according to conditions of the base stations. Referring to FIG. 2C, there is shown a schematic view illustrating that the first user direct mode communication apparatus 11 according to the second embodiment of the present invention firstly chooses the base station before synchronization.

Specifically, the network further comprises a second base station 3b therein. When the first user direct mode communication apparatus 11 is to perform the synchronization, the transceiver 111 of the first user direct mode communication apparatus 11 firstly receives first base station information 310 and second base station information 312 from the first base station 3a and the second base station 3b respectively.

Then, the processor 113 of the first user direct mode communication apparatus 11 is further configured to choose the first base station 3a as the synchronization target from among the first base station 3a and the second base station 3b according to the first base station information 310 and the second base station information 312, and in a manner as described above in the second embodiment, receive the synchronization signal 30 from the first base station 3a to complete the subsequent synchronization operation.

It shall be particularly appreciated that, the first base station information 310 and the second base station information 312 may comprise base station related information including a base station signal strength, a base station loading condition, a base station signal interference level, or a base station identification code or the like. Then, the processor 113 of the first user direct mode communication apparatus 11 can determine (may also choose a target base station randomly according to the base station identification code) a target base station for synchronization accordingly.

Furthermore, in other implementations where there is a plurality of base stations in the network, the first user direct mode communication apparatus 11 may also receive synchronization signals from different base stations firstly, and then calculate the synchronization time according to the weights of the different base stations. Referring to FIG. 2D, there is shown a schematic view illustrating that the first user direct mode communication apparatus 11 according to the second embodiment of the present invention directly performs the synchronization with respect to different base stations.

Specifically, the network further comprises a first base station 3x and a second base station 3y therein. When the first user direct mode communication apparatus 11 is to perform the synchronization, the transceiver 111 of the first user direct mode communication apparatus 11 directly receives a first synchronization signal 316 and a second synchronization signal 318 from the first base station 3x and the second base station 3y respectively. The first synchronization signal 316 comprises first time information 3160 and first apparatus information 3162. The second synchronization signal 318 comprises second time information 3180 and second apparatus information 3182.

Then, the processor 113 of the first user direct mode communication apparatus 11 further determines a first apparatus weight (not depicted) of the first base station 3x according to the first apparatus information 3162, and determine a second apparatus weight (not depicted) of the second base station 3y according to the second apparatus information 3182. Afterwards, the processor 113 further calculates a network synchronization time T6 according to the first apparatus weight, the second apparatus weight, the first time information 3160 and the second time information 3180.

It shall be particularly appreciated that, the aforesaid base station apparatus weight may be decided according to the base station signal conditions, and the first user direct mode communication apparatus 11 may, according to weights of different base stations, determine to: (a) use the time information of one of the base stations that has a higher weight as the synchronization time directly, or (b) adjust usage percentages of the time information of the base stations of different weights.

For example, if the first apparatus weight of the first base station 3x is higher, then the network synchronization time T6 is calculated mainly according to the first time information 3160 of the first base station 3x directly. Alternatively, the network synchronization time T6 may be determined, according to the ratio of the first apparatus weight to the second apparatus weight, to be calculated on the basis of the ratio of the first time information 3160 to the second time information 3180.

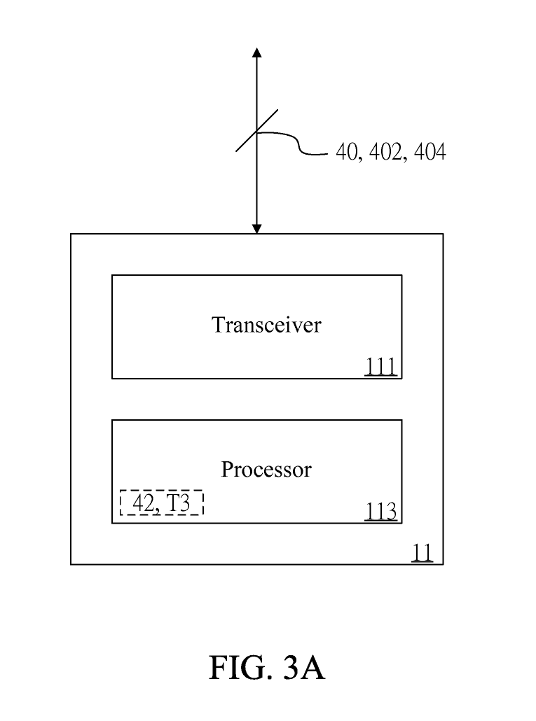

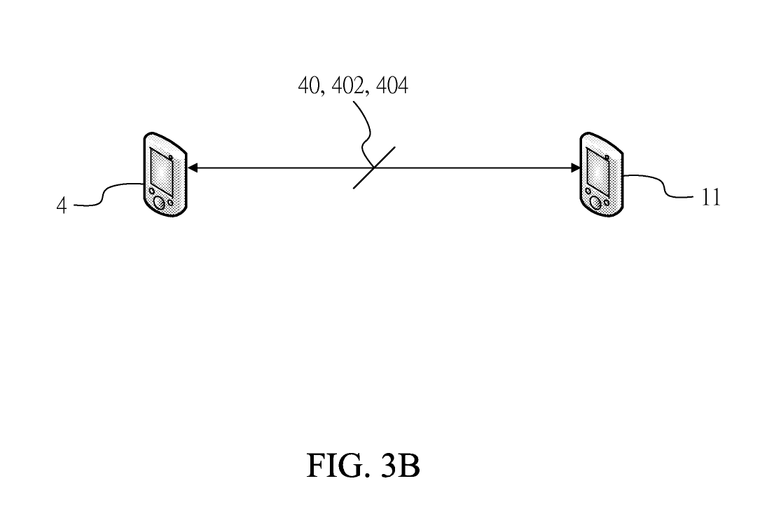

Please refer to FIGS. 3A-3B together. FIG. 3A is a block diagram of a first user direct mode communication apparatus 11 according to a third embodiment of the present invention. FIG. 3B is a schematic view illustrating that the first user direct mode communication apparatus 11 according to the third embodiment of the present invention performs time synchronization. It shall be particularly appreciated that, the architecture of the third embodiment is the same as that of the previous embodiments, so components bearing the same reference numerals also have the same functions and, thus, will not be further described herein. However, the third embodiment mainly describes a case where the network apparatus is a user direct mode communication apparatus.

Firstly, when the first user direct mode communication apparatus 11 needs to perform the time synchronization, it mainly searches for any apparatus in the network that transmits a synchronization signal. In the third embodiment, the transceiver 111 of the first user direct mode communication apparatus 11 receives a synchronization signal 40 from a second user direct mode communication apparatus 4. The synchronization signal 40 comprises time information 402 and apparatus information 404.

Next, the processor 113 of the first user direct mode communication apparatus 11 may determine that the apparatus weight of the second user direct mode communication apparatus 4 is a second user direct mode communication apparatus weight 42 according to the apparatus information 404. Finally, the processor 113 of the first user direct mode communication apparatus 11 calculates a network synchronization time T3 according to the second user direct mode communication apparatus weight 42 and the time information 402 to complete the time synchronization of the first user direct mode communication apparatus 11.

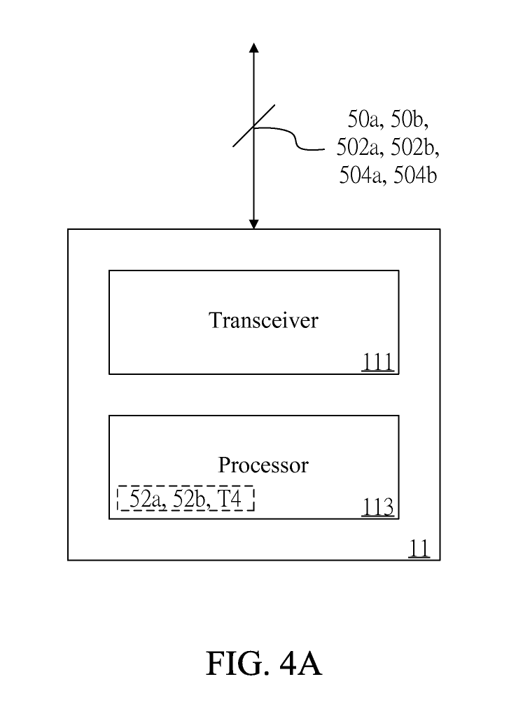

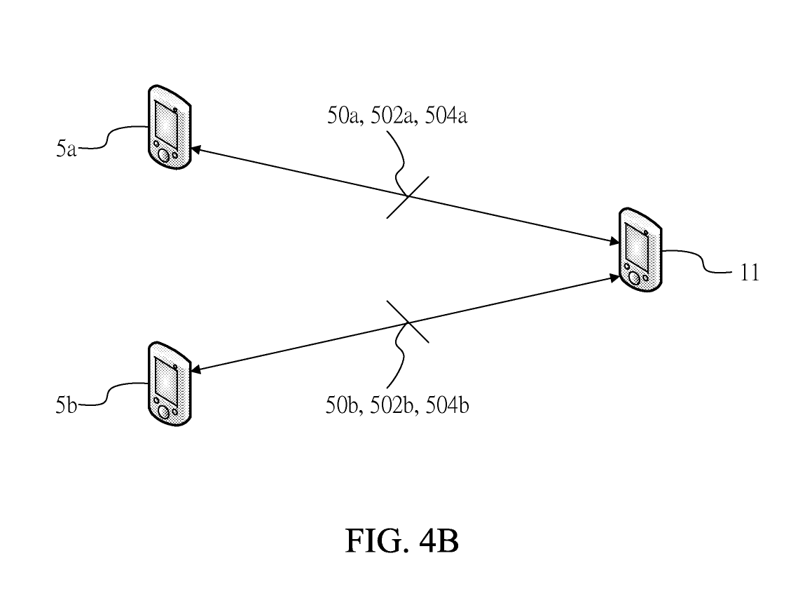

Please refer to FIGS. 4A-4B together. FIG. 4A is a block diagram of a first user direct mode communication apparatus 11 of a fourth embodiment of the present invention. FIG. 4B is a schematic view illustrating that the first user direct mode communication apparatus 11 according to the fourth embodiment of the present invention performs time synchronization. It shall be particularly appreciated that, the architecture of the fourth embodiment is the same as that of the previous embodiments, so components bearing the same reference numerals also have the same functions and, thus, will not be further described herein. However, the fourth embodiment mainly describes a case where the network apparatus is a plurality of user direct mode communication apparatuses.

Firstly, when the first user direct mode communication apparatus 11 needs to perform the time synchronization, it mainly searches for any apparatus in the network that transmits a synchronization signal. In the fourth embodiment, the transceiver 111 of the first user direct mode communication apparatus 11 receives a synchronization signal 50a from a second user direct mode communication apparatus 5a, and receives a synchronization signal 50b from a second user direct mode communication apparatus 5b. The synchronization signal 50a comprises time information 502a and apparatus information 504a, and the synchronization signal 50b comprises time information 502b and apparatus information 504b.

Next, the processor 113 of the first user direct mode communication apparatus 11 may determine that apparatus weights of the second user direct mode communication apparatus 5a and the second user direct mode communication apparatus 5b are a second user direct mode communication apparatus weight 52a and a second user direct mode communication apparatus weight 52b respectively according to the apparatus information 504a and 504b. Finally, the processor 113 of the first user direct mode communication apparatus 11 calculates a network synchronization time T4 according to the second user direct mode communication apparatus weights 52a, 52b and the time information 502a, 502b to complete the time synchronization of the first user direct mode communication apparatus 11.

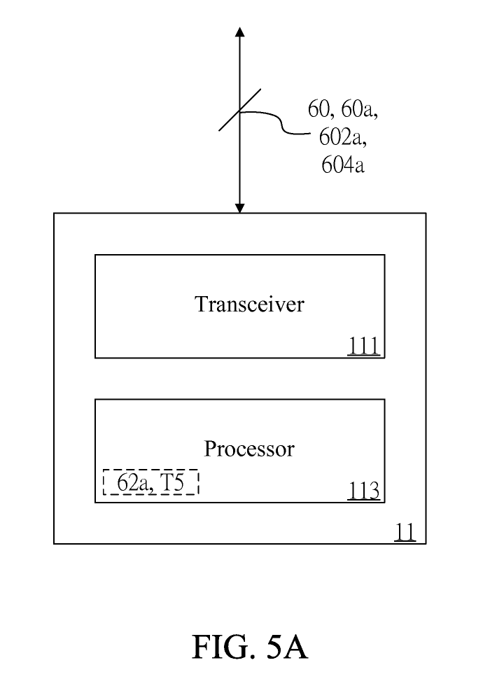

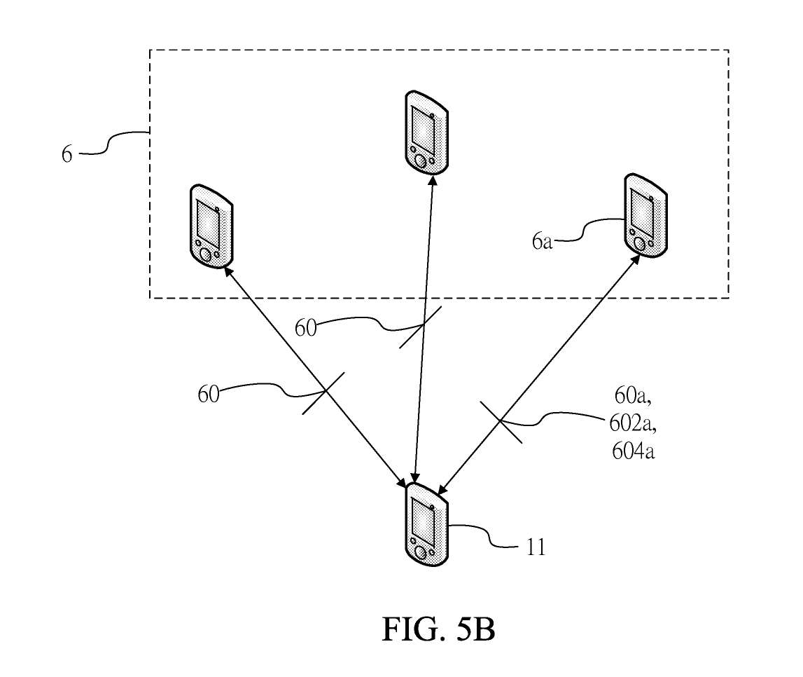

Please refer to FIGS. 5A-5B together. FIG. 5A is a block diagram of a first user direct mode communication apparatus 11 according to a fifth embodiment of the present invention. FIG. 5B is a schematic view illustrating that the first user direct mode communication apparatus 11 according to the fifth embodiment of the present invention performs time synchronization. It shall be particularly appreciated that, the architecture of the fifth embodiment is the same as that of the previous embodiments, so components bearing the same reference numerals also have the same functions and, thus, will not be further described herein. However, the fifth embodiment mainly describes a case where the first user direct mode communication apparatus 11 chooses a main synchronization target from a plurality of user direct mode communication apparatuses.

Firstly, when the first user direct mode communication apparatus 11 needs to perform the time synchronization, it mainly searches for any apparatus in the network that transmits a synchronization signal. In the fifth embodiment, the transceiver 111 of the first user direct mode communication apparatus 11 receives a plurality of second user synchronization signals 60 from a plurality of second user direct mode communication apparatuses 6.

Next, the processor 113 of the first user direct mode communication apparatus 11 chooses a third user synchronization signal 60a complying with the quality requirements according to conditions (e.g., signal strengths, synchronization message hopping numbers of times or the like) of the plurality of second user synchronization signals 60. The third user synchronization signal 60a corresponds to a third user direct mode communication apparatus 6a among the plurality of second user direct mode communication apparatuses 6, and comprises third user time information 602a and third user apparatus information 604a.

Afterwards, the processor 113 of the first user direct mode communication apparatus 11 may determine a third user direct mode communication apparatus weight 62a of the third user direct mode communication apparatus 6a according to the third user apparatus information 604a. Finally, the processor 113 of the first user direct mode communication apparatus 11 calculates a network synchronization time T5 according to the third user direct mode communication apparatus weight 62a and the third user time information 602a to complete the time synchronization of the first user direct mode communication apparatus 11.

Hereinafter, the practical operations of the embodiments described above will be further explained with reference to exemplary examples thereof. Specifically, in the embodiments described above, the first user direct mode communication apparatus may calculate the synchronization time according to the formula

$${x}_{0} = {\sum }_{i = 0}^{n} {a}_{i} {x}_{i} , {\sum }_{i = 0}^{n} {a}_{i} = 1 ,$$

where x₀ is the derived synchronization time of the first user direct mode communication apparatus, xᵢ is the synchronization time comprised in the synchronization signal transmitted by each of the other network apparatuses, and aᵢ is the corresponding apparatus weight.

In more detail, when the first user direct mode communication apparatus is located within a communication coverage of a base station, the first user direct mode communication apparatus can receive the synchronization signal of the base station, and set the apparatus weight of the base station to be 1 and the apparatus weights of the other user direct mode communication apparatuses to be 0. In this way, the derived synchronization time x₀ of the first user direct mode communication apparatus is just the synchronization time comprised in the synchronization signal of the base station.

On the other hand, when the first user direct mode communication apparatus is located outside the communication coverage of the base station, the first user direct mode communication apparatus may allocate apparatus weights to different user direct mode communication apparatuses depending on the conditions (e.g., signal strengths, synchronization message hopping numbers of times or the like) of synchronization signals of the different user direct mode communication apparatuses, and as shown in the above formula, a sum of the apparatus weights is 1. In this way, the derived synchronization time x₀ of the first user direct mode communication apparatus is just the sum of products of the synchronization times and the apparatus weights of the individual user direct mode communication apparatuses.

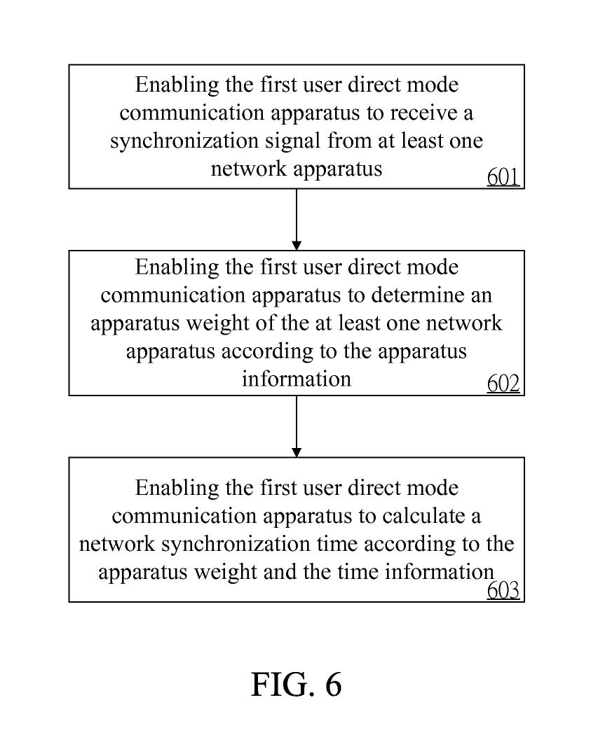

A sixth embodiment of the present invention is a time synchronization method, a flowchart diagram of which is shown in FIG. 6. The method of the sixth embodiment is used for a first user direct mode communication apparatus (e.g., the first user direct mode communication apparatus 11 of the previous embodiments). Detailed steps of the sixth embodiment are described as follows.

Firstly, step 601 is executed to enable the first user direct mode communication apparatus to receive a synchronization signal from at least one network apparatus. The synchronization signal comprises time information and apparatus information. Then, step 602 is executed to enable the first user direct mode communication apparatus to determine an apparatus weight of the at least one network apparatus according to the apparatus information. Finally, step 603 is executed to enable the first user direct mode communication apparatus to calculate a network synchronization time according to the apparatus weight and the time information.

Likewise, in other more detailed implementations, when the apparatus information further comprises an apparatus signal strength or a synchronization message hopping number of times, the first user direct mode communication apparatus may further determine reliability of the at least one network apparatus (i.e., determine the apparatus weight of the at least one network apparatus) according to the apparatus signal strength or the synchronization message hopping number of times after the step 602.

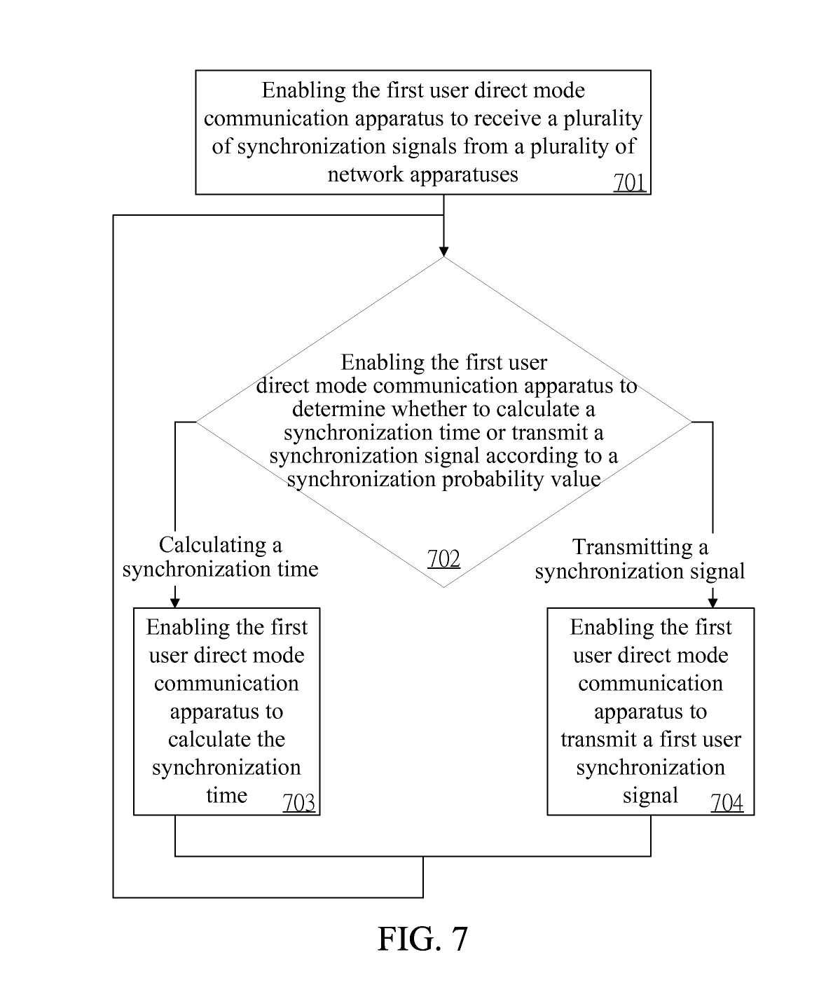

A seventh embodiment of the present invention is a time synchronization method, a flowchart diagram of which is shown in FIG. 7. The method of the seventh embodiment is used for a first user direct mode communication apparatus (e.g., the first user direct mode communication apparatus 11 of the previous embodiments). Detailed steps of the seventh embodiment are described as follows.

Firstly, step 701 is executed to enable the first user direct mode communication apparatus to receive a plurality of synchronization signals from a plurality of network apparatuses. Each of the synchronization signals comprises time information and apparatus information. Then, step 702 is executed to enable the first user direct mode communication apparatus to determine whether to calculate a synchronization time or transmit a synchronization signal according to a synchronization probability value.

If the first user direct mode communication apparatus chooses to calculate the synchronization time according to the synchronization probability value, then step 703 is executed to enable the first user direct mode communication apparatus to calculate the synchronization time according to the formula

$${x}_{0} = {\sum }_{i = 0}^{n} {a}_{i} {x}_{i} , {\sum }_{i = 0}^{n} {a}_{i} = 1 ,$$

where x₀ is the derived synchronization time of the first user direct mode communication apparatus, xᵢ is the synchronization time comprised in the synchronization signal transmitted by each of other network apparatuses, and aᵢ is the corresponding apparatus weight.

In the seventh embodiment, if the plurality of network apparatuses include a base station, it means that the first user direct mode communication apparatus can receive the synchronization signal of the base station. Then, the first user direct mode communication apparatus sets the apparatus weight of the base station to be 1 and the apparatus weights of other network apparatuses to be 0. Therefore, according to the above formula, the derived synchronization time x₀ of the first user direct mode communication apparatus is just the synchronization time comprised in the synchronization signal of the base station.

On the other hand, if the plurality of network apparatuses don't include a base station, it means that the first user direct mode communication apparatus can only receive the synchronization signals of the user direct mode communication apparatuses. Then, the first user direct mode communication apparatus directly allocates apparatus weights to different user direct mode communication apparatuses depending on conditions (e.g., signal strengths, synchronization message hopping numbers of times or the like) of the synchronization signals of the different user direct mode communication apparatuses, and as shown in the above equation, the sum of the apparatus weights is 1. Therefore, according to the above formula, the derived synchronization time x₀ of the first user direct mode communication apparatus is just the sum of products of the synchronization times and the apparatus weights of the individual user direct mode communication apparatuses.

On the contrary, if the first user direct mode communication apparatus chooses to transmit a synchronization message according to the synchronization probability value, then step 704 is executed to enable the first user direct mode communication apparatus to transmit a first user synchronization signal of the first user direct mode communication apparatus so that the other user direct mode communication apparatuses calculate their own synchronization times.

It shall be particularly appreciated that, as shown in the flowchart diagram, after the step 703 or the step 704 is executed by the first user direct mode communication apparatus according to the synchronization probability value, the first user direct mode communication apparatus will re-determine whether to execute the step 703 or the step 704 according to the synchronization probability value during the synchronization period.

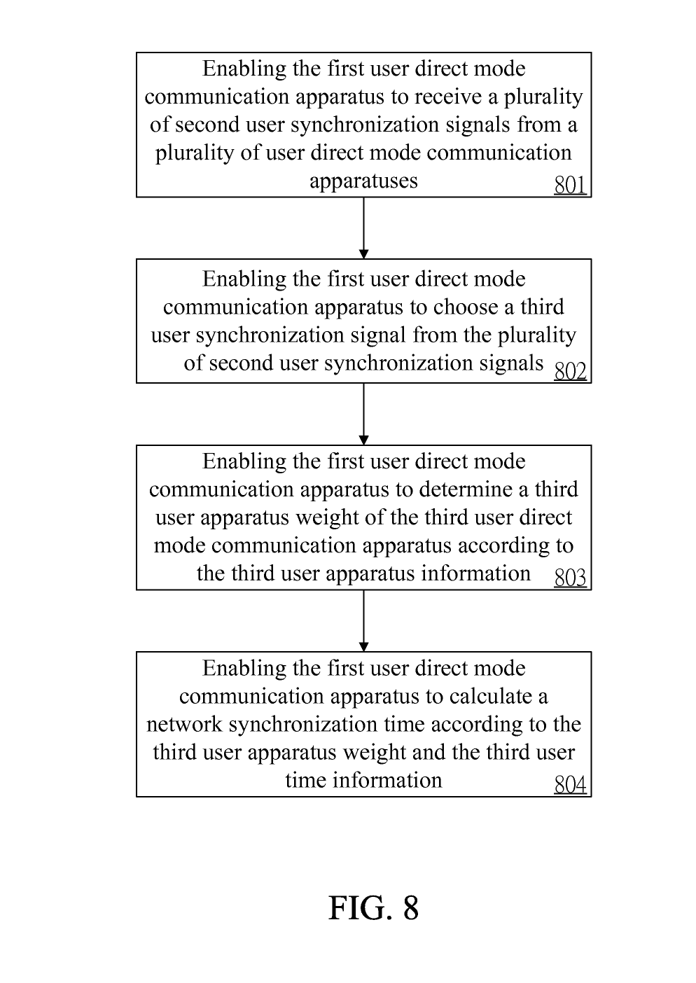

An eighth embodiment of the present invention is a time synchronization method, a flowchart diagram of which is shown in FIG. 8. The method of the eighth embodiment is used for a first user direct mode communication apparatus (e.g., the first user direct mode communication apparatus 11 of the previous embodiments). Detailed steps of the eighth embodiment are described as follows.

Firstly, step 801 is executed to enable the first user direct mode communication apparatus to receive a plurality of second user synchronization signals from a plurality of user direct mode communication apparatuses. Each of the second user synchronization signals comprises time information and apparatus information. Then, step 802 is executed to enable the first user direct mode communication apparatus to choose a third user synchronization signal from the plurality of second user synchronization signals. The third user synchronization signal corresponds to a third user direct mode communication apparatus among the second user direct mode communication apparatuses, and comprises third user time information and third user apparatus information.

Step 803 is executed to enable the first user direct mode communication apparatus to determine a third user apparatus weight of the third user direct mode communication apparatus according to the third user apparatus information. Finally, step 804 is executed to enable the first user direct mode communication apparatus to calculate a network synchronization time according to the third user apparatus weight and the third user time information. In the step 802, the first user direct mode communication apparatus may choose a user synchronization signal complying with the quality requirements as the third user synchronization signal according to the conditions (e.g., signal strengths, synchronization message hopping numbers of times or the like) of the plurality of second user synchronization signals.

It shall be particularly appreciated that, the above formula may also be used in the eighth embodiment to calculate the synchronization time by simply setting the third user apparatus weight of the chosen third user direct mode communication apparatus to be 1 and setting the apparatus weights of the other user direct mode communication apparatuses to be 0. In this way, the synchronization time can be calculated according to the synchronization signal of a single user direct mode communication apparatus.

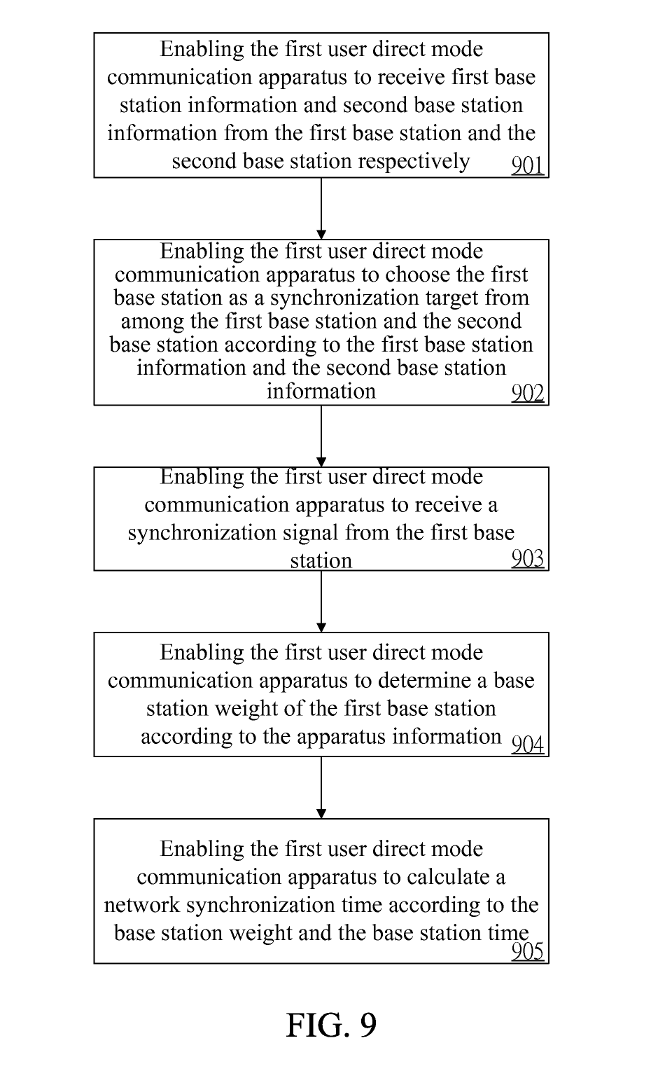

A ninth embodiment of the present invention is a time synchronization method, a flowchart diagram of which is shown in FIG. 9. The method of the ninth embodiment is used for a first user direct mode communication apparatus (e.g., the first user direct mode communication apparatus 11 of the previous embodiments). Detailed steps of the ninth embodiment are described as follows.

Firstly, step 901 is executed to enable the first user direct mode communication apparatus to receive first base station information and second base station information from a first base station and a second base station respectively. Step 902 is executed to enable the first user direct mode communication apparatus to choose the first base station as a synchronization target from among the first base station and the second base station according to the first base station information and the second base station information. Step 903 is executed to enable the first user direct mode communication apparatus to receive a synchronization signal from the first base station. The synchronization signal comprises a base station time and apparatus information of the first base station.

Then, step 904 is executed to enable the first user direct mode communication apparatus to determine a base station weight of the first base station according to the apparatus information. The base station weight is used for the first user direct mode communication apparatus to determine that the network apparatus is a base station. Finally, step 905 is executed to enable the first user direct mode communication apparatus to calculate a network synchronization time according to the base station weight and the base station time. The network synchronization time is the base station time.

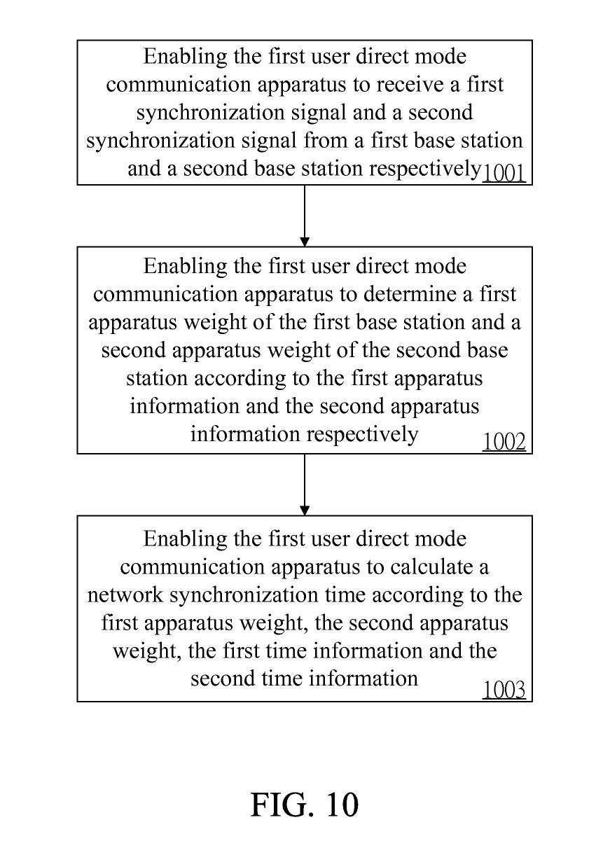

A tenth embodiment of the present invention is a time synchronization method, a flowchart diagram of which is shown in FIG. 10. The method of the tenth embodiment is used for a first user direct mode communication apparatus (e.g., the first user direct mode communication apparatus 11 in the previous embodiments). Detailed steps of the tenth embodiment are described as follows.

Firstly, step 1001 is executed to enable the first user direct mode communication apparatus to receive a first synchronization signal and a second synchronization signal from a first base station and a second base station respectively. The first synchronization signal comprises first time information and first apparatus information, and the second synchronization signal comprises second time information and second apparatus information.

Then, step 1002 is executed to enable the first user direct mode communication apparatus to determine a first apparatus weight of the first base station and a second apparatus weight of the second base station according to the first apparatus information and the second apparatus information respectively. Finally, step 1003 is executed to enable the first user direct mode communication apparatus to calculate a network synchronization time according to the first apparatus weight, the second apparatus weight, the first time information and the second time information.

According to the above description, the user direct mode communication apparatus of the present invention and the time synchronization method thereof can assign different weights depending on different network apparatuses so as to accomplish the time synchronization accurately both within and outside the communication coverage of the base station in a more flexible manner, thus overcoming the shortcoming in the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A time synchronization method for a first user direct mode communication apparatus, the method comprising:
(a) receiving by the first user direct mode communication apparatus a synchronization signal from at least one network apparatus, wherein the synchronization signal comprises time information and apparatus information;
(b) determining by the first user direct mode communication apparatus an apparatus weight of the at least one network apparatus according to the apparatus information; and
(c) calculating by the first user direct mode communication apparatus a network synchronization time according to the apparatus weight and the time information.

2. The time synchronization method of claim 1, wherein the apparatus information further comprises an apparatus signal strength or a synchronization message hopping number of times, and the step (b) further comprising:
(b1) determining by the first user direct mode communication apparatus the apparatus weight of the at least one network apparatus according to the apparatus signal strength or the synchronization message hopping number of times.

3. The time synchronization method of claim 1, further comprising the following after the step (a):
(a1) transmitting by the first user direct mode communication apparatus a first user synchronization signal of the first user direct mode communication apparatus according to a synchronization probability value.

4. The time synchronization method of claim 1, wherein the at least one network apparatus includes a first base station, the time information comprises a base station time of the first base station, the apparatus weight comprises a base station weight of the first base station, and the step (c) further comprises:
(c1) calculating by the first user direct mode communication apparatus the network synchronization time according to the base station weight and the base station time, wherein the network synchronization time is the base station time.

5. The time synchronization method of claim 4, wherein the at least one network apparatus further includes a second base station, and the step (a) further comprises:
(a1) receiving by the first user direct mode communication apparatus a first base station information and a second base station information from the first base station and the second base station respectively;
(a2) choosing by the first user direct mode communication apparatus the first base station as a synchronization target from among the first base station and the second base station according to the first base station information and the second base station information; and
(c3) receiving by the first user direct mode communication apparatus the synchronization signal from the first base station.

6. The time synchronization method of claim 1, wherein the at least one network apparatus includes a first base station and a second base station, and the step (a) further comprises:
(a1) receiving by the first user direct mode communication apparatus a first synchronization signal and a second synchronization signal from the first base station and the second base station respectively, wherein the first synchronization signal comprises first time information and first apparatus information, and the second synchronization signal comprises second time information and second apparatus information;
wherein the step (b) comprises:
(b1) determining by the first user direct mode communication apparatus a first apparatus weight of the first base station and a second apparatus weight of the second base station according to the first apparatus information and the second apparatus information respectively; and
wherein the step (c) further comprises:
(c1) calculating by the first user direct mode communication apparatus the network synchronization time according to the first apparatus weight, the second apparatus weight, the first time information and the second time information.

7. The time synchronization method of claim 1, wherein the at least one network apparatus includes at least one second user direct mode communication apparatus, the time information comprises a second user time of the at least one second user direct mode communication apparatus, the apparatus weight comprises a second user apparatus weight of the at least one second user direct mode communication apparatus, and the step (c) further comprises:
(c1) calculating by the first user direct mode communication apparatus the network synchronization time according to the second user apparatus weight and the second user time.

8. The time synchronization method of claim 1, wherein the at least one network apparatus includes a plurality of second user direct mode communication apparatuses, and the synchronization signal comprises a plurality of second user synchronization signals of the second user direct mode communication apparatuses, the time synchronization method further comprising the following after the step (a):
(a1) choosing by the first user direct mode communication apparatus a third user synchronization signal from the second user synchronization signals, wherein the third user synchronization signal corresponds to a third user direct mode communication apparatus among the second user direct mode communication apparatuses and comprises third user time information and third user apparatus information;
wherein the step (b) further comprises:
(b1) determining by the first user direct mode communication apparatus a third user apparatus weight of the third user direct mode communication apparatus according to the third user apparatus information; and
wherein the step (c) further comprises:
(c1) calculating by the first user direct mode communication apparatus the network synchronization time according to the third user apparatus weight and the third user time information.

9. A first user direct mode communication apparatus, comprising:
a transceiver, being configured to receive a synchronization signal from at least one network apparatus, wherein the synchronization signal comprises time information and apparatus information; and
a processor, being configured to:
determine an apparatus weight of the at least one network apparatus according to the apparatus information; and
calculate a network synchronization time according to the apparatus weight and the time information.

10. The first user direct mode communication apparatus of claim 9, wherein the apparatus information further comprises an apparatus signal strength or a synchronization message hopping number of times, and the processor is further configured to determine the apparatus weight of the at least one network apparatus according to the apparatus signal strength or the synchronization message hopping number of times.

11. The first user direct mode communication apparatus of claim 9, wherein the processor is further configured to transmit a first user synchronization signal of the first user direct mode communication apparatus according to a synchronization probability value.

12. The first user direct mode communication apparatus of claim 9, wherein the at least one network apparatus includes a first base station, the time information comprises a base station time of the first base station, the apparatus weight comprises a base station weight of the first base station, the processor is further configured to calculate the network synchronization time according to the base station weight and the base station time, and the network synchronization time is the base station time.

13. The first user direct mode communication apparatus of claim 12, wherein the at least one network apparatus further includes a second base station, the transceiver is further configured to receive first base station information and second base station information from the first base station and the second base station respectively, and the processor is further configured to choose the first base station as a synchronization target from among the first base station and the second base station according to the first base station information and the second base station information, and receive the synchronization signal from the first base station.

14. The first user direct mode communication apparatus of claim 9, wherein the at least one network apparatus includes a first base station and a second base station, and the transceiver is further configured to receive a first synchronization signal and a second synchronization signal from the first base station and the second base station respectively, the first synchronization signal comprises first time information and first apparatus information, and the second synchronization signal comprises second time information and second apparatus information, and the processor is further configured to determine a first apparatus weight of the first base station and a second apparatus weight of the second base station according to the first apparatus information and the second apparatus information respectively, and calculate the network synchronization time according to the first apparatus weight, the second apparatus weight, the first time information and the second time information.

15. The first user direct mode communication apparatus of claim 9, wherein the at least one network apparatus includes at least one second user direct mode communication apparatus, the time information comprises a second user time of the at least one second user direct mode communication apparatus, the apparatus weight comprises a second user apparatus weight of the at least one second user direct mode communication apparatus, and the processor is further configured to calculate the network synchronization time according to the second user apparatus weight and the second user time.

16. The first user direct mode communication apparatus of claim 9, wherein the at least one network apparatus includes a plurality of second user direct mode communication apparatuses, and the synchronization signal comprises a plurality of second user synchronization signals of the second user direct mode communication apparatuses, the processor is further configured to:
choose a third user synchronization signal from the second user synchronization signals, wherein the third user synchronization signal corresponds to a third user direct mode communication apparatus among the second user direct mode communication apparatuses and comprises third user time information and third user apparatus information,
determine a third user apparatus weight of the third user direct mode communication apparatus according to the third user apparatus information; and
calculate the network synchronization time according to the third user apparatus weight and the third user time information.
